(19) United States
(12) Patent Application Publication
(10) Pub. No.: US 2016/0334163 A1
(43) Pub. Date: Nov. 17, 2016

(54) DEVICE FOR DRIVING AND CONTROLLING A ROTATING MACHINE OF A PROCESSING PLANT, AND PROCESSING PLANT COMPRISING SUCH A DRIVE AND CONTROL DEVICE

(71) Applicant: VICAT, Paris la Défense (FR)

(72) Inventors: Eric BOURDON, Lyon (FR); Alain HUBERSON, Miribel (FR); Jacques WOILLEZ, Sainte Foy Les Lyon (FR); Olivier CREPON, Lyon (FR)

(21) Appl. No.: 15/111,503

(22) PCT Filed: Dec. 29, 2014
(86) PCT No.: PCT/FR2014/053570

§ 371 Date: Jul. 14, 2016

(30) Foreign Application Priority Data
Jan. 16, 2014 (FR) 14/50339

(51) Int. Cl. F27D 17/00; F01K 13/02; F01K 7/16

(52) U.S. Cl. CPC F27D 17/004; F01K 7/165; F01K 13/02; F27D 17/001; F27D 2017/006

(57) ABSTRACT

A drive and control device includes a turbine provided with an output shaft capable of providing a first drive torque and an electric motor having an output shaft capable of providing a second drive torque. The device further includes a coupling component for coupling the rotation of the turbine and electric motor output shafts with the rotating machine of the treatment facility. The device further includes a control unit for controlling the operation of the electric motor and the turbine. The control unit is arranged to define a setpoint value of an operating parameter of the rotating machine in accordance with at least one characteristic quantity of the operation of the treatment facility (2), and to regulate turbine and electric motor operating parameters in accordance with the at least one characteristic quantity to bring the value of the operating parameter of the rotating machine closer to the defined setpoint value.

### TECHNICAL FIELD

The present disclosure relates to a drive and control device for a rotating machine of a processing plant, and a processing plant comprising such a drive and control device.

### BACKGROUND

A processing plant, and more particularly a cooling plant of a hot product, comprises in a known manner:
a cooling enclosure of the hot product,
a feed chute arranged to bring the hot product inside the cooling enclosure,
a discharge chute arranged to discharge the cooled product outside from the cooling enclosure,
an insufflation duct arranged to insufflate the cooling gas, such as cold air, inside the cooling enclosure, and
an extraction duct arranged to extract hot fumes, consisting of the cooling gas and dust coming from contacts between the cooling gas and the hot product, from the outside of the cooling enclosure, the extraction duct being equipped with an exhaust fan driven by an electric motor.

In such a cooling plant, the discharged hot fumes may reach temperatures higher than 200° C., even higher than 300° C. Thus, the thermal energy lost by such a cooling plant proves to be significant.

In order to recover a part of the thermal energy lost by a cooling plant and thus to increase the energy efficiency thereof, a first known solution consists in thermally coupling a heat exchanger to the extraction duct so that the hot fumes flowing therethrough heat a heat transfer fluid flowing through the heat exchanger. The calories recovered by the heat transfer fluid may be then used, for example, for a heating or drying operation in a processing plant neighboring the cooling plant.

Such a recovery mode, although economic and efficient, is not adapted for production sites non-equipped with plant likely to use recovered calories on the cooling plant.

A second known solution consists in transforming a part of the thermal energy lost by the cooling plant into electrical energy. Such a solution consists more particularly in providing, in the cooling plant, for an energy conversion circuit in which a heat transfer fluid is intended to flow and comprising:
an evaporator able to be heated by the hot fumes flowing through the extraction duct and able to vaporize the heat transfer fluid flowing in the energy conversion circuit,
a turbine able to be driven by the heat transfer fluid vaporized by the evaporator and able to drive an alternator intended to produce electricity, and
a condenser able to condense the vaporized heat transfer fluid discharged by the turbine, and
a pump able to pressurize the condensed heat transfer fluid and to redirect the pressurized heat transfer fluid in the evaporator.

A third known solution consists in transforming a part of the thermal energy lost by the cooling plant into mechanical energy and directly using this mechanical energy to rotatably drive the exhaust fan, and this, so as to be free of an alternator, and thus to increase the energy efficiency of the cooling plant, the compactness and the cost thereof.

This third solution consists, more particularly, in providing for a second extraction duct arranged to extract hot fumes outside from the cooling enclosure, connecting the second extraction duct to the extraction duct equipped with the exhaust fan, providing for an energy conversion circuit as described hereinabove, thermally coupling the evaporator to the second extraction duct and finally rotatably coupling the output shaft of the turbine to the exhaust fan.

However, such a solution has several drawbacks, in particular when used in the context of a clinker cooling method.

Firstly, at the start-up of the plant, it is required to preheat the cooling enclosure (for example using heat of a burner of a neighboring kiln) so as to have the initial thermal energy required for the start-up of the turbine and the exhaust fan.

Then, during operation of the plant, it may happen that, due to fluctuations of the production method of the clinker, the thermal power of the turbine then decreases while, at the same time, the power of the exhaust fan needs to be maximum. It may follow an insufficient extraction of the hot fumes, and therefore a decrease of the efficiency of the plant, even a degradation thereof.

Finally, in case of failure of the turbine or the evaporator of the energy conversion circuit, the entire cooling plant may end up in default.

The present disclosure aims to remedy these drawbacks.

### SUMMARY

The technical problem underlying the disclosure relates to providing a drive and control device of a rotating machine of a processing plant, and more particularly of a cooling plant, which ensures optimum and reliable operation of the processing plant irrespective of the operation conditions thereof.

To this end, the present disclosure concerns a drive and control device of a rotating machine, such as a fan and, in particular, an exhaust fan, of a processing plant, for example a cooling plant of a hot product, such as a clinker coming from a kiln, the drive and control device comprising:
a turbine provided with an output shaft able to provide a drive torque,
an electric motor provided with an output shaft able to provide a drive torque,
coupling means arranged to rotatably couple the output shafts of the turbine and of the electric motor to the rotating machine of the processing plant, and
a control unit arranged to control the operation of the electric motor and of the turbine, the control unit being arranged to define a setpoint value of an operation parameter of the rotating machine, such as the speed of rotation of the rotating machine, depending on at least one characteristic variable of the operation of the processing plant, and to regulate an operation parameter of the turbine and an operation parameter of the electric motor depending on the at least one characteristic variable so as to bring the value of the operation parameter of the rotating machine closer to the defined setpoint value.

Such a configuration of the drive and control device allows, in case of failure of the turbine and during the start-up phases of the processing plant, ensuring an optimum speed of rotation of the rotating machine simply by controlling the operation of the electric motor so as to reach the defined setpoint value.

In addition, the presence of the electric motor allows, when the drive torque provided by the turbine is insufficient, in particular, due to fluctuations in the production method of the hot product, providing an additional drive torque so as to keep an optimum rotational drive of the rotating machine.

Thus, the electric motor allows providing a drive torque able to complete or replace the drive torque provided by the turbine under some operation conditions of the processing plant.

However, under optimum operation conditions of the processing plant, only the turbine is supplied, thereby limiting the electric energy consumption of the processing plant.

Consequently, the combination of an electric motor to a turbine allows ensuring a high efficiency of the processing plant and a reliable operation of the latter, and this, regardless of the operation conditions of the processing plant.

According to one embodiment of the disclosure, the drive and control device is configured to drive and control a rotating machine of a processing plant equipped with at least one extraction duct of hot fumes, such as a vent or chimney. The processing plant may be for example a boiler, in particular, of a thermal power plant, a cement pre-heater or even a blast furnace.

According to one embodiment of the disclosure, the rotating machine might be for example a pump, a compressor, an elevator, a conveyor, a grinder, an exhaust fan or any type of fan equipping a processing plant equipped with at least one extraction duct of hot fumes.

According to one embodiment of the disclosure, the control unit is able to simultaneously regulate the operation parameter of the turbine, such as the speed of rotation of the turbine, and the operation parameter of the electric motor, such as the speed of rotation of the electric motor, depending on the at least one characteristic variable of the operation of the processing plant so as to bring the value of the operation parameter of the rotating machine closer to the defined setpoint value.

According to an advantageous characteristic of the disclosure, the control unit is arranged to control the operation of the electric motor and of the turbine according to at least:
a nominal operation mode in which the turbine is supplied and provides a drive torque and the electric motor does not provide a drive torque, and in which the control unit regulates the operation parameter of the turbine so as to bring the value of the operation parameter of the rotating machine closer to the defined setpoint value, and
a hybrid operation mode in which the electric motor is electrically supplied and provides a drive torque and the turbine is supplied and provides a drive torque, and in which the control unit simultaneously regulates the operation parameter of the turbine and the operation parameter of the electric motor so as to bring the value of the operation parameter of the rotating machine closer to the defined setpoint value.

According to one embodiment of the disclosure, the control unit is arranged to control the operation of the electric motor and of the turbine according to at least one failure mode in which the turbine is not supplied and the electric motor is electrically supplied and provides a drive torque, and in which the control unit regulates the operation parameter of the electric motor so as to bring the value of the operation parameter of the rotating machine closer to the defined setpoint value.

Advantageously, the drive and control device comprises means for determining the operation parameter of the rotating machine. These determination means include, for example a speed sensor arranged to determine the speed of rotation of the rotating machine.

According to one embodiment of the disclosure, the control unit is arranged to regulate the operation parameter of the electric motor depending on the at least one characteristic variable and the operation parameter of the rotating machine.

According to one embodiment of the disclosure, the drive and control device comprises means for determining the operation parameter of the turbine, such as the speed of rotation of the turbine. These determination means include, for example, a speed sensor arranged to determine the speed of rotation of the turbine.

According to one embodiment of the disclosure, the control unit is arranged to regulate the operation parameter of the turbine depending on the at least one characteristic variable and the operation parameter of the turbine.

According to one embodiment of the disclosure, the control unit is arranged to compare the actual operation parameter of the rotating machine with the defined setpoint value.

According to one embodiment of the disclosure, the control unit is arranged to control the switch from the nominal operation mode to the hybrid operation mode when a switch condition is detected by the control unit. The switch condition may be for example the elapse of a predetermined period of time without the operation parameter of the rotating machine could be able to reach the defined setpoint value.

According to another advantageous characteristic of the disclosure, the control unit is arranged to control the operation of the electric motor and of the turbine according to at least one start-up mode in which the turbine is not supplied and does not provide a drive torque and the electric motor is electrically supplied and provides a drive torque, and in which the control unit regulates the operation parameter of the electric motor so as to bring the value of the operation parameter of the rotating machine closer to the defined setpoint value.

The drive and control device comprises, for example at least one determination element arranged to determine the at least one operation characteristic of the processing plant. The determination element may be a pressure sensor, and for example a pressure sensor configured to determine the pressure in a processing enclosure of the processing plant. The determination member might also be a flow rate sensor, and for example a flow rate sensor configured to determine the flow rate of a forced draught fan of the processing plant, the flow rate of an extraction duct of hot fumes of the processing plant or even the flow rate of a hot product or a fuel through the processing enclosure. The determination element might also be a temperature sensor, and for example a temperature sensor configured to determine the temperature of the hot fumes flowing in an extraction duct of hot fumes of the processing plant.

According to one embodiment of the disclosure, the control unit is arranged to compare the at least one determined characteristic variable by the determination element with a predetermined setpoint value.

According to one embodiment of the disclosure, the control unit comprises a first speed regulator arranged to regulate the speed of rotation of the turbine, and a second speed regulator arranged to regulate the speed of rotation of the electric motor.

According to one embodiment of the disclosure, the control unit comprises a controller arranged to control the first and second speed regulators depending on the at least one characteristic variable. According to this embodiment of the disclosure, the controller may also be called master regulator, and the first and second speed regulators may be called first and second slave regulators respectively.

According to one embodiment of the disclosure, the controller is arranged to determine and transmit a first control setpoint to the first speed regulator and a second control setpoint to the second speed regulator.

According to one embodiment of the disclosure, the controller is configured such that, when the electric motor and the turbine are in nominal operation mode, the value of the second control setpoint transmitted to the second speed regulator is lower, and preferably slightly lower, than the value of the first control setpoint transmitted to the first speed regulator, so as the speed regulation of the rotating machine by means of the second speed regulator is triggered only if the speed of the turbine is insufficient for a predetermined time.

According to one embodiment of the disclosure, when the electric motor and the turbine are in nominal operation mode, the second speed regulator is arranged to transmit a torque setpoint to the electric motor only if a switch condition is detected by the controller, which switch condition is triggered only if the defined setpoint value is not reached with the first speed regulator.

According to one embodiment of the disclosure, the controller is linked to the determination element and is arranged to compare the predetermined value and the determined characteristic variable.

According to one embodiment of the disclosure, the controller is arranged to control the first and second speed regulators depending on the difference between the predetermined value and the at least one determined characteristic variable.

According to one embodiment of the disclosure, the coupling means include a coupling system able to be coupled to the rotating machine of the processing plant so as to transmit an output torque to the rotating machine, the coupling system being arranged to rotatably couple the output shaft of the turbine and the output shaft of the electric motor.

It should be noted that the coupling system used in the present disclosure is in particular known in the field of the mechanical equipments, in particular for driving an alternator by two turbine wheels or for driving a single propeller shaft from two motors on a ship.

According to one embodiment of the disclosure, the coupling system comprises at least one first portion coupled to the output shaft of the turbine, a second portion coupled to the output shaft of the electric motor, and a third portion able to be coupled to the rotating machine.

The drive and control device may for example comprise a clutch element movable between an engaged position in which the turbine is able to be coupled to the rotating machine and a disengaged position in which the turbine is unable to be coupled to the rotating machine. More particularly, the clutch element may be movable between an engaged position in which the turbine is coupled to the coupling system and a disengaged position in which the turbine is decoupled from the coupling system.

Advantageously, the drive and control device comprises an energy conversion circuit able to convert the thermal energy lost by the processing plant into mechanical energy and in which a heat transfer fluid is intended to flow, the energy conversion circuit including the turbine and being able to supply the turbine with heat transfer fluid. The energy conversion circuit comprises, for example, a supply member such as a supply valve, disposed upstream of the turbine and arranged to adjust the heat transfer fluid supply flow rate of the turbine.

According to one embodiment of the disclosure, the control unit is arranged to control the switch from the nominal operation mode to the failure mode when a failure condition is detected. The failure condition may be, for example the detection of a failure of the turbine or of the energy conversion circuit, and for example a failure of the evaporator or of the condenser. The failure condition may also be the fact that the speed of rotation of the rotating machine reaches a minimum threshold value.

According to one embodiment of the disclosure, the control unit is arranged to adjust the position of the supply member belonging to the energy conversion circuit depending on the at least one characteristic variable of the processing plant operation so as to regulate the heat transfer fluid supply flow rate of the turbine, and then the speed of rotation of the turbine.

According to one embodiment of the disclosure, the energy conversion circuit further comprises an evaporator able to be heated by a thermal energy source lost by the processing plant, such as a flow of hot fumes discharged by the processing plant, and able to vaporize and pressurize the heat transfer fluid flowing in the energy conversion circuit, the turbine being able to be driven by the vaporized and pressurized heat transfer fluid.

According to one embodiment of the disclosure, the energy conversion circuit comprises a condenser able to condense the expanded heat transfer fluid discharged by the turbine. The energy conversion circuit further comprises a recirculation element, such as a pump or a compressor, arranged to direct the condensed heat transfer fluid to the evaporator.

According to one embodiment of the disclosure, the control unit is able to control the operation of the turbine and of the electric motor depending on at least one characteristic variable of the operation of the energy conversion circuit, such as the temperature at the inlet of the turbine.

The present disclosure further concerns a processing plant, for example a cooling plant of a hot product, such as a clinker coming from a kiln, the processing plant comprising:
a drive and control device according to the disclosure,
a processing enclosure, and more particularly a cooling enclosure,
a first extraction duct arranged to extract hot fumes from outside the processing enclosure, the first extraction duct being equipped with an exhaust fan rotatably coupled to the output shafts of the electric motor and the turbine of the drive and control device.

According to one embodiment of the disclosure, the processing plant further comprises a feed chute arranged to bring the hot product inside the processing enclosure, and a discharge chute arranged to discharge the cooled product outside from the processing enclosure.

According to one embodiment of the disclosure, the control unit is able to define the setpoint value of the operation parameter of the fan depending on at least one characteristic variable of the operation of the processing enclosure, such as the pressure of the processing enclosure.

According to one embodiment of the disclosure, the control unit is able to regulate the operation parameter of the turbine and the operation parameter of the electric motor depending on the at least one characteristic variable of the operation of the processing enclosure, so as to bring the value of the operation parameter of the fan closer to the defined setpoint value.

Advantageously, the processing plant further comprises a second extraction duct arranged to extract hot fumes outside from the processing enclosure, the second extraction duct being connected to the first extraction duct upstream of the exhaust fan and being thermally coupled to the energy conversion circuit.

According to one embodiment of the disclosure, the second extraction duct is fluidly linked to the evaporator of the energy conversion circuit such that the evaporator is heated by hot fumes flowing through the second extraction duct. The evaporator is thus arranged to vaporize the heat transfer fluid of the energy conversion circuit from calories drawn from the hot fumes circulating in the second extraction duct.

According to one embodiment of the disclosure, the second extraction duct comprises a first duct portion arranged to fluidly link the processing enclosure to an inlet of the evaporator, and a second duct portion arranged to fluidly link an outlet of the evaporator to the first extraction duct.

According to one embodiment of the disclosure, the first extraction duct is equipped with a setting member disposed upstream of the connection area between the first and second extraction ducts and arranged to set the flow rate of hot fumes in the first extraction duct.

According to one embodiment of the disclosure, the control unit is arranged to set the position of the setting member provided on the first extraction duct so as to modify the flow rate of hot fumes in the first extraction duct.

According to one embodiment of the disclosure, the second extraction duct is equipped with an intake member, such as an intake valve, disposed upstream of the evaporator and arranged to adjust the hot fume supply flow rate of the evaporator.

According to one embodiment of the disclosure, the control unit is arranged to set the position of the intake member provided on the second extraction duct so as to modify the hot fume supply flow rate of the evaporator.

According to one embodiment of the disclosure, the processing plant comprises a third extraction duct arranged to extract hot fumes outside from the processing enclosure and supply a kiln by combustion air.

According to one embodiment of the disclosure, the first discharge duct comprises a heat exchanger, such as an air cooler or air/air cooler, disposed upstream of the exhaust fan and arranged to regulate the temperature of hot fumes flowing in the first discharge duct. The heat exchanger may be disposed upstream or downstream of the connection area of the first and second discharge ducts.

According to one embodiment of the disclosure, the first discharge duct comprises a filter disposed upstream of the exhaust fan, and for example, between the heat exchanger and the exhaust fan. The filter is, for example a dedusting filter. According to one embodiment of the disclosure, the filter is disposed downstream of the connection area of the first and second discharge ducts.

According to one embodiment of the disclosure, the processing plant comprises an insufflation duct arranged to insufflate cooling gas inside the processing enclosure. The insufflation duct may, for example, comprise at least one forced draught fan.

According to one embodiment of the disclosure, the processing plant comprises a measuring element arranged to measure the temperature of the cooled product, and a control unit arranged to adjust the cooling air flow rate depending on the measured temperature by the measuring member.

According to one embodiment of the disclosure, the failure condition may be, for example, the fact that the temperature of the cooled product reaches a maximum cooled product temperature value, the fact that the pressure in the processing enclosure reaches a maximum pressure value, or even the fact that the temperature of hot fumes at the inlet of the filter reaches a maximum filter temperature value.

The present disclosure further concerns a control method for controlling a rotating machine of a processing plant, for example a cooling plant of a hot product, such as a clinker coming from a kiln, the control method including the following steps:
providing for a drive and control device according to the disclosure,
coupling the electric motor and the turbine to the rotating machine of the processing plant,
determining at least one characteristic variable of the operation of the processing plant,
defining a setpoint value of an operation parameter of the rotating machine depending on the at least one determined characteristic variable,
regulating an operation parameter of the turbine and an operation parameter of the electric motor depending on the at least one determined characteristic variable so as to bring the value of the operation parameter of the rotating machine closer to the defined setpoint value.

According to one mode of implementation of the control method, the control step comprises a step regulating the speeds of rotation of the turbine and of the electric motor depending on the at least one determined characteristic variable so as to bring the value of the operation parameter of the rotating machine closer to the defined setpoint value.

According to one mode of implementation of the control method, the control step comprises a step regulating the heat transfer fluid supply flow rate of the turbine depending on the at least one determined characteristic variable.

According to one mode of implementation of the control method, the latter comprises a start-up step comprising the following steps:
electrically supplying the electric motor and maintaining the turbine at shutdown or in free rotation, and
regulating the operation parameter of the electric motor depending on the at least one determined characteristic variable so as to bring the value of the operation parameter of the rotating machine closer to the defined setpoint value.

According to one mode of implementation of the control method, the control step comprises a nominal operation step:
not electrically supplying the electric motor and supplying the turbine, and
regulating the operation parameter of the turbine depending on the at least one determined characteristic variable so as to bring the value of the operation parameter of the rotating machine closer to the defined setpoint value.

According to one mode of implementation of the control method, the control step comprises a hybrid operation step:
electrically supplying the electric motor and supplying the turbine, and
regulating the operation parameter of the turbine and the operation parameter of the electric motor depending on the at least one determined characteristic variable so as to bring the value of the operation parameter of the rotating machine closer to the defined setpoint value.

According to one mode of implementation of the control method, the control step comprises a failure step:
detecting a failure condition,
stopping the supply of the turbine,
electrically supplying the electric motor, and
regulating the operation parameter of the electric motor depending on the at least one determined characteristic variable so as to bring the value of the operation parameter of the rotating machine closer to the defined setpoint value.

### BRIEF DESCRIPTION OF THE DRAWING

In any case, the disclosure will be better understood through the following description with reference to the appended schematic drawing showing, by way of non limiting example, an embodiment of this processing plant:

FIG. 1 is a schematic view of a processing plant according to the disclosure.

### DETAILED DESCRIPTION OF THE DRAWING

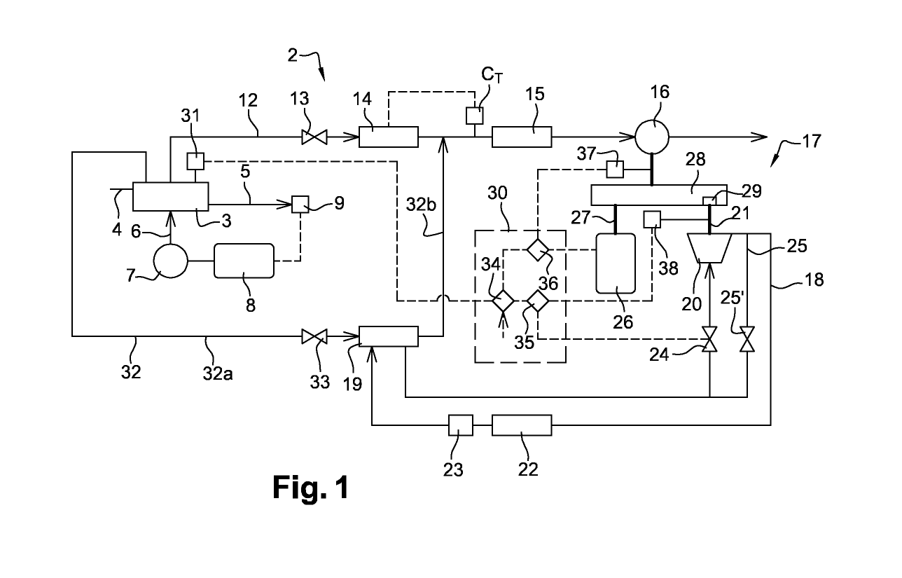

FIG. 1 shows a processing plant, and more particularly a cooling plant 2 of a hot product, such as a clinker coming from a kiln.

The cooling plant 2 comprises in particular a cooling enclosure 3, a feed chute 4 arranged to bring the hot product inside the cooling enclosure 3, a discharge chute 5 arranged to discharge the cooled product outside from the cooling enclosure 3, and a insufflation duct 6 arranged to insufflate the cooling gas, such as cold air, inside the cooling enclosure 3.

According to the embodiment shown in FIG. 1, the insufflation duct 6 comprises at least one forced draught fan 7 and one electric motor 8 rotatably coupled to the forced draught fan 7 and arranged to rotatably drive the forced draught fan 7. The cooling plant 2 comprises a temperature sensor 9 arranged to measure the temperature of the cooled product.

The cooling plant 2 also comprises an extraction duct 12 arranged to extract hot fumes outside from the cooling enclosure 3. The extraction duct 12 is equipped successively, from the cooling enclosure 3, with a setting valve 13 arranged to set the flow rate of hot fumes in the extraction duct 12, with a heat exchanger 14, such as an air cooler or air/air cooler, arranged to regulate the temperature of hot fumes flowing in the discharge duct 12, with a filter 15, such as a dedusting filter, and with an exhaust fan 16. The cooling plant 2 also comprises a temperature sensor Cᵣ arranged to measure the temperature of hot fumes at the inlet of the filter 15.

The cooling plant 2 further comprises a hybrid drive and control device 17 arranged to drive and control the exhaust fan 16.

The drive and control device 17 comprises an energy conversion circuit 18 able to convert the thermal energy lost by the cooling plant 2 into mechanical energy and in which a heat transfer fluid is intended to flow, such as, for example, water or a refrigerant. The energy conversion circuit 18 includes an evaporator 19 able to be heated by a thermal energy source lost by the cooling plant 2 and able to vaporize the heat transfer fluid flowing in the energy conversion circuit 18, a turbine 20 able to be driven by the vaporized heat transfer fluid and provided with an output shaft 21 able to provide a drive torque, a condenser 22 able to condense the expanded heat transfer fluid discharged by the turbine 20, and optionally 23 a recirculation element, such as a pump or a compressor, arranged to direct the condensed heat transfer fluid to the evaporator 19.

The energy conversion circuit 18 also comprises a supply valve 24 disposed upstream of the turbine 20 and arranged to adjust the heat transfer fluid supply flow rate of the turbine 20.

The energy conversion circuit 18 further comprises a bypass duct 25 equipped with an setting member 25′ movable between a closed position in which the heat transfer fluid coming from the evaporator 19 supplies the turbine 20, and an open position in which the heat transfer fluid coming from the evaporator 19 bypasses the turbine 20.

The drive and control device 17 further comprises an electric motor 26 provided with an output shaft 27 able to provide a drive torque, and a coupling system 28 arranged to rotatably couple the output shafts 21, 27 of the turbine 20 and of the electric motor 26 to the exhaust fan 16. The coupling system 28 is arranged to receive at the inlet the drive torques provided by the output shafts 21, 27 of the turbine 20 and of the electric motor 26, and to output a single output torque intended to be applied to the exhaust fan 16. According to one embodiment of the disclosure, the coupling system 28 comprises a first portion coupled to the output shaft 21 of the turbine 20, a second portion coupled to the output shaft 27 of the electric motor 26, and a third portion coupled to the exhaust fan 16.

The coupling system 28 may, for example, be of the toothed belt type, and in this case a coupler, for example a hydraulic coupler, is provided on the output shaft of the turbine 20, or even of the gear type.

The drive and control device 17 further comprises a clutch element 29 movable between an engaged position in which the turbine 20 is coupled to the coupling system 28 and a disengaged position in which the turbine 20 is decoupled from the coupling system 28.

The drive and control device 17 further includes a control unit 30 whose structure and operation will be described in more detail hereinafter, and a determination element 31 arranged to determine an operation characteristic of the cooling enclosure 3, such as the pressure of the cooling enclosure 3. The determination element 31 is more particularly arranged to determine the pressure in the upper part of the cooling enclosure 3, that is to say the part of the cooling enclosure 3 in which the hot product does not flow. The determination element 31 is advantageously a pressure sensor.

The cooling plant 2 further comprises an extraction duct 32 arranged to extract hot fumes outside from the cooling enclosure 3. The extraction duct 32 is connected to the extraction duct 12 upstream of the exhaust fan 16 and is thermally coupled to the evaporator 19. According to the embodiment shown in the FIGURE, the connection area of the extraction ducts 12, 32 is located between the heat exchanger 14 and the filter 15.

The extraction duct 32 is fluidly linked to the evaporator 19 such that the evaporator 19 is heated by hot fumes flowing through the extraction duct 32. The evaporator 19 is thus arranged to vaporize the heat transfer fluid of the energy conversion circuit 18 from calories drawn from the hot fumes circulating in the extraction duct 32. According to the embodiment shown in the FIGURE, the extraction duct 32 comprises a first duct portion 32a arranged to fluidly link the cooling enclosure 3 to an inlet of the evaporator 19, and a second duct portion 32b arranged to fluidly link an outlet of the evaporator 19 to the extraction duct 12.

The extraction duct 32 is equipped with an intake valve 33 disposed upstream of the evaporator 19 and arranged to adjust the hot fume supply flow rate of the evaporator 19.

The control unit 30 comprises more particularly a controller 34 arranged to define a setpoint value of an operation parameter of the fan 16, such as the speed of rotation of the fan 16, depending on the characteristic variable determined by the determination element 31.

The control unit 30 also comprises a speed regulator 35 arranged to regulate the speed of rotation of the turbine 20, and a speed regulator 36 arranged to regulate the speed of rotation of the electric motor 26. The speed regulator 35 is more particularly arranged to adjust the position of the supply valve 24 belonging to the energy conversion circuit 18 so as to regulate the heat transfer fluid supply flow rate of the turbine 20, and then the speed of rotation of the turbine 20.

The drive and control device 17 further includes a determination element 37 arranged to determine an actual operation parameter of the exhaust fan 16, such as the speed of rotation of the exhaust fan 16, and a determination member 38 arranged to determine an actual operation parameter of the turbine 20, such as the speed of rotation of the turbine 20. The determination elements 37, 38 may, for example, be angular speed sensors.

The speed regulator 35 is arranged to regulate the speed of rotation of the turbine 20, and more precisely the position of the supply valve 24, depending on the characteristic variable determined by the determination member 31 and on the operation parameter determined by the determination member 38, and the speed regulator 36 is arranged to regulate the speed of rotation of the electric motor 26 depending on the characteristic variable determined by the determination element 31 and on the operation parameter determined by the determination element 37, and this, so as to bring the value of the operation parameter of the fan 16 closer to the defined setpoint value.

The controller 34 is more particularly arranged to transmit a first and a second control setpoints respectively to the first and second speed regulators 35, 36, the first and second control setpoints being determined depending on the characteristic variable determined by the determination element 31.

According to a nominal operation mode of the drive and control device 17 in which the turbine 20 provides a drive torque and the electric motor 26 does not provide a drive torque, the controller 34 is configured such that the value of the second control setpoint transmitted to the second speed regulator 36 is lower than the value of the first control setpoint transmitted to the first speed regulator 35.

According to nominal operation mode of the drive and control device 17, the second speed regulator 36 is arranged to transmit a torque setpoint to the electric motor 26 only when a switch condition is detected by the controller 34.

The switch condition may be for example the elapse of a predetermined period of time without the operation parameter of the exhaust fan 16 could reach the defined setpoint value with the first speed regulator.

It should be noted that the controller 34 is arranged to modify the operation of the cooling plant when a failure condition is detected. The failure condition may be the detection of a failure of the energy conversion circuit 18, and for example a failure of the evaporator 19, the turbine 20, or even the condenser 22. The failure condition may also be the fact that the speed of rotation of the exhaust fan 16 reaches a minimum threshold value, the fact that the temperature of the cooled product reaches a maximum cooled product temperature value, the fact that the pressure in the cooling enclosure 3 reaches a maximum pressure value, or even the fact that the temperature of hot fumes at the inlet of the filter 15 reaches a maximum filter temperature value.

According to one embodiment of the disclosure, the controller 34 is arranged, on the one hand, to compare the characteristic variable determined by the determination element 31 with a predetermined value, for example, an input value input by an operator using a data input means, such as a keyboard, and on the other hand, to control the speed regulators 35, 36 depending on the difference between the predetermined value and the determined characteristic variable so as to bring the value of the operation parameter of the fan closer to the defined setpoint value.

The controller 34 is also arranged to set the position of the setting valve 13 provided on the extraction duct 12 so as to modify the flow rate of hot fumes in the extraction duct 12, and to set the position of the intake valve 33 provided on the extraction duct 32 so as to modify the hot fume supply flow rate of the evaporator 19.

The controller 34 is further arranged to set the position of the setting member 25′ belonging to the energy conversion circuit 18 between its open and closed positions.

It should be noted that the control unit 30 is also arranged to regulate the speed of rotation of the electric motor 8 depending on the temperature measured by the temperature sensor 9 so as to adjust the cooling air flow rate in the insufflation duct 6.

The control method of the exhaust fan 16 will now be described considering initially that the setting valve 13 is open, the setting member 25′ is closed, the intake valve 33 is closed, the clutch element 29 is in its disengaged position, the evaporator 19 is cold and the turbine 20 is at shutdown.

The control method comprises a start-up step comprising the following steps:
electrically supplying the electric motor 26,
determining the characteristic variable of the operation of the cooling enclosure 3 using the determination element 31,
defining, using the controller 34, a setpoint value of the operation parameter of the fan 16 depending on the determined characteristic variable,
regulating the speed of rotation of the electric motor 26 using the speed regulator 36 so as to bring the value of the operation parameter of the fan 16 closer to the defined setpoint value,
after a predetermined period has elapsed, ordering the total or partial opening of the intake valve 33 and the total or partial closure of the setting valve 13 in order to heat the evaporator 19 with the hot fumes flowing in the extraction duct 12
when predetermined vaporization conditions are reached in the evaporator 19, ordering the opening of the intake valve 24 in order to preheat the turbine 20,
when a predetermined threshold temperature is reached in the turbine 20, enabling the regulation of the speed of rotation of the turbine 20 depending on the determined characteristic variable using the speed regulator 35, the value of the control setpoint transmitted to the speed regulator 35 being identical to the value of the control setpoint transmitted to the speed regulator 36, and
when the speed of the turbine 20 is equal to that of the electric motor 26, ordering the displacement of the clutch element 29 in its engaged position, ordering the total opening of the intake valve 33 and the positioning of the setting valve 13 in a nominal position adapted to ensure the desired flow rates of hot fumes in the extraction ducts 12, 33, and transmitting to the speed regulator 36 a control setpoint value lower than the value of the control setpoint transmitted to the speed regulator 35.

The control method further comprises a nominal operation step includes regulating the speed of rotation of the turbine 20 using the speed regulator 35 so as to bring the value of the operation parameter of the fan 16 closer to the defined setpoint value.

The control method also comprises a hybrid operation step which is implemented if the defined setpoint value is not reached, during the nominal operation step, after a predetermined period has elapsed.

The hybrid operation step comprises the following steps:
comparing the actual operation parameter of the exhaust fan 16 with the defined setpoint value, and
regulating the speeds of rotation of the turbine 20 and of the electric motor 26 depending on the determined characteristic variable so as to bring the value of the operation parameter of the fan 16 closer to the defined setpoint value.

In case of detection of a failure condition by the controller 34, the control method comprises the following steps:
regulating the speed of rotation of the electric motor 26 using the speed regulator 36 depending on the at least one determined characteristic variable so as to bring the value of the operation parameter of the fan 16 closer to the defined setpoint value,
ordering the closing of the intake valve 33 and the total opening of the setting valve 13,
ordering the displacement of the setting member 25′ in its open position, and the closing of the supply valve 24,
displacing the clutch element 29 in its disengaged position, and
gradually cooling the energy conversion circuit 18 by means of the heat exchanger 19 until a shutdown of the energy conversion circuit 18.

It goes without saying that the disclosure is not limited to the sole embodiment of this processing plant, described hereinabove by way of example, it encompasses, on the contrary, all the variants. Thus, this is in particular how the processing plant might be for example a boiler of a thermal power plant, a cement preheater or a blast furnace.

1. A drive and control device for a rotating machine of a processing plant, the drive and control device comprising:
a turbine provided with an output shaft,
an electric motor provided with an output shaft,
coupling means arranged to rotatably couple the output shafts of the turbine and of the electric motor to the rotating machine of the processing plant, and
a control unit arranged to control the operation of the electric motor and of the turbine, the control unit being arranged to define a setpoint value of an operation parameter of the rotating machine depending on at least one characteristic variable of the operation of the processing plant, and to regulate an operation parameter of the turbine and an operation parameter of the electric motor depending on the at least one characteristic variable so as to bring the value of the operation parameter of the rotating machine closer to the defined setpoint value.

2. The drive and control device according to claim 1, wherein the control unit is able to simultaneously regulate the operation parameter of the turbine and the operation parameter of the electric motor depending on the at least one characteristic variable so as to bring the value of the operation parameter of the rotating machine closer to the defined setpoint value.

3. The drive and control device according to claim 1, wherein the control unit is arranged to control the operation of the electric motor and of the turbine according to at least:
a nominal operation mode in which the turbine provides a drive torque and the electric motor does not provide a drive torque, and in which the control unit regulates the operation parameter of the turbine so as to bring the value of the operation parameter of the rotating machine closer to the defined setpoint value, and
a hybrid operation mode in which the electric motor provides a drive torque and the turbine provides a drive torque, and in which the control unit regulates the operation parameter of the turbine and the operation parameter of the electric motor so as to bring the value of the operation parameter of the rotating machine closer to the defined setpoint value.

4. The drive and control device according to claim 1, wherein the control unit is arranged to control the operation of the electric motor and of the turbine according to at least:
a start-up mode in which the electric motor provides a drive torque and the turbine is not supplied, and in which the control unit regulates the operation parameter of the electric motor so as to bring the value of the operation parameter of the rotating machine closer to the defined setpoint value.

5. The drive and control device according to claim 1, wherein the control unit is arranged to control the operation of the electric motor and of the turbine according to at least:
a failure mode in which the electric motor provides a drive torque and the turbine is not supplied, and in which the control unit regulates the operation parameter of the electric motor so as to bring the value of the operation parameter of the rotating machine closer to the defined setpoint value.

6. The drive and control device according to claim 1, wherein the control unit comprises a first speed regulator arranged to regulate the speed of rotation of the turbine, a second speed regulator arranged to regulate the speed of rotation of the electric motor and a controller arranged to control the first and second speed regulators depending on the at least one characteristic variable.

7. The drive and control device according to claim 6, wherein the controller is arranged to determine and transmit a first control setpoint to the first speed regulator and a second control setpoint to the second speed regulator, and is configured such that, when the electric motor and the turbine are in nominal operation mode, the value of the second control setpoint transmitted to the second speed regulator is lower than the value of the first control setpoint transmitted to the first speed regulator.

8. The drive and control device according to claim 1, which comprises at least one determination element arranged to determine the at least one operation characteristic of the processing plant.

9. The drive and control device according to claim 1, wherein the coupling means include a coupling system able to be coupled to the rotating machine of the processing plant so as to transmit an output torque to the rotating machine, the coupling system being arranged to rotatably couple the output shaft of the turbine and the output shaft of the electric motor.

10. The drive and control device according to of claim 1, which comprises a clutch element movable between an engaged position in which the turbine is able to be coupled to the rotating machine and a disengaged position in which the turbine is unable to be coupled to the rotating machine.

11. The drive and control device according to claim 1, which comprises an energy conversion circuit able to convert thermal energy lost by the processing plant into mechanical energy and in which a heat transfer fluid is intended to flow, the energy conversion circuit including the turbine and being able to supply the turbine with the heat transfer fluid.

12. The drive and control device according to claim 11, wherein the energy conversion circuit comprises a supply member disposed upstream of the turbine and arranged to adjust the heat transfer fluid supply flow rate of the turbine.

13. The drive and control device according to claim 11, wherein the energy conversion circuit further comprises an evaporator able to be heated by a thermal energy source lost by the processing plant and able to vaporize the heat transfer fluid flowing in the energy conversion circuit, the turbine being able to be driven by the vaporized heat transfer fluid.

14. A processing plant comprising:
a drive and control device according to claim 1,
a processing enclosure, and
a first extraction duct arranged to extract hot fumes outside from the processing enclosure, the first extraction duct being equipped with an exhaust fan rotatably coupled to the output shafts of the electric motor and of the turbine of the drive and control device.

15. The processing plant according to claim 14, which further comprises a second extraction duct arranged to extract hot fumes outside from the processing enclosure, the second extraction duct being connected to the first extraction duct upstream of the exhaust fan and being thermally coupled to the energy conversion circuit.

16. A control method for controlling a rotating machine of a processing plant, the control method comprising the following steps:
providing a drive and control device according to of claim 1,
coupling the electric motor and the turbine to the rotating machine of the processing plant,
determining at least one characteristic variable of the operation of the processing plant,
defining a setpoint value of an operation parameter of the rotating machine depending on the at least one determined characteristic variable, and
regulating an operation parameter of the turbine and an operation parameter of the electric motor depending on the at least one determined characteristic variable so as to bring the value of the operation parameter of the rotating machine closer to the defined setpoint value.
